(19) United States
(12) Patent Application Publication
(10) Pub. No.: US 2021/0063279 A1
(43) Pub. Date: Mar. 4, 2021

(54) EXTERNAL LIQUID PROTECTION SHIELD FOR SENSOR PROBE

(71) Applicant: CUMMINS EMISSION SOLUTIONS INC., Columbus, IN (US)

(72) Inventor: Steven Leslie Charles, Chester Le Street (GB)

(73) Assignee: CUMMINS EMISSION SOLUTIONS INC., Columbus, IN (US)

(21) Appl. No.: 17/002,464

(22) Filed: Aug. 25, 2020

Related U.S. Application Data
(60) Provisional application No. 62/892,736, filed on Aug. 28, 2019.

(51) Int. Cl. G01M 15/02; G01M 15/10; B60R 13/08; F01N 13/14; F01N 13/18

(52) U.S. Cl. CPC G01M 15/02; G01M 15/102; F01N 13/1805; F01N 13/14; B60R 13/0876

(57) ABSTRACT

A liquid protection shield for a sensor probe in an exhaust system is provided. The liquid protection shield includes a sensor tip housing portion having a substantially cylindrical shape and multiple apertures formed through a sidewall of the sensor tip housing portion. The liquid protection shield further includes a shoulder portion integrally coupled to the sensor tip housing portion and having a substantially cylindrical shape. The sensor tip housing portion and the shoulder portion collectively define a central passage for the sensor probe.

### CROSS-REFERENCE TO RELATED APPLICATIONS

The present application claims the benefit of U.S. Provisional Application No. 62/892,736, filed Aug. 28, 2019, the entire disclosure of which is hereby incorporated by reference herein.

### TECHNICAL FIELD

The present application relates generally to the field of sensor systems for exhaust systems. More specifically, the present application relates to a liquid protection shield for a sensor probe in an exhaust system.

### BACKGROUND

For internal combustion engines, such as diesel or natural gas engines, nitrogen oxide (NOₓ) compounds may be emitted in the exhaust of a vehicle. To reduce NOₓ emissions, a selective catalytic reduction (SCR) process may be implemented to convert the NOₓ compounds into more neutral compounds, such as diatomic nitrogen, water, or carbon dioxide, with the aid of a catalyst and a reductant. The catalyst may be included in a catalyst chamber of an exhaust system. A reductant, such as anhydrous ammonia, aqueous ammonia, or urea is typically introduced into the exhaust gas flow prior to the catalyst chamber. To introduce the reductant into the exhaust gas flow for the SCR process, an SCR system may dose or otherwise introduce the reductant through a dosing module that vaporizes or sprays the reductant into an exhaust pipe of the exhaust system up-stream of the catalyst chamber.

### SUMMARY

In one embodiment, a liquid protection shield for a sensor probe in an exhaust system includes a sensor tip housing portion and a shoulder portion. The sensor tip housing portion has a substantially cylindrical shape and multiple apertures formed through a sidewall of the sensor tip housing portion. The shoulder portion is integrally coupled to the sensor tip housing portion and has a substantially cylindrical shape. The sensor tip housing portion and the shoulder portion collectively define a central passage for the sensor probe.

In some embodiments, the multiple apertures include a range of two apertures to nine apertures. In some embodiments, the multiple apertures include six apertures disposed at equal intervals about a circumference of the sensor tip housing portion.

In some embodiments, a diameter of each aperture is in a range from 1.5 mm to 3.0 mm.

In some embodiments, the liquid protection shield further comprises: a barrier wall disposed at an end of the sensor tip housing portion that is opposite the shoulder portion, wherein the plurality of apertures are disposed proximate to the barrier wall.

In some embodiments, the sensor tip housing portion defines a tip receiving region that is substantially encapsulated by the sidewall of the sensor tip housing portion and the barrier wall, the tip receiving region configured to receive a sensor tip of the sensor probe.

In some embodiments, the liquid protection shield is fabricated from stainless steel.

In some embodiments, the shoulder portion includes an internal threaded region configured to be threaded with an external threaded region of the sensor probe.

In some embodiments, the shoulder portion further comprises a flat face that interrupts the substantially cylindrical shape of the shoulder portion.

In some embodiments, an aftertreatment system for treating constituents of an exhaust gas generated by an engine, comprises: an exhaust pipe; at least one aftertreatment component disposed within the exhaust pipe; a liquid protection shield coupled to a wall of the exhaust pipe, the liquid protection shield comprising: a sensor tip housing portion having a substantially cylindrical shape and comprising a plurality of apertures formed through a sidewall of the sensor tip housing portion, and a shoulder portion integrally coupled to the sensor tip housing portion and having a substantially cylindrical shape, the sensor tip housing portion and the shoulder portion collectively defining a central passage for the sensor probe; and a sensor probe, at least a portion of the sensor probe being disposed in the central passage.

In some embodiments, the plurality of apertures comprises a range of two apertures to nine apertures.

In some embodiments, the plurality of apertures comprises six apertures disposed at equal intervals about a circumference of the sensor tip housing portion.

In some embodiments, a diameter of each of the plurality of apertures is in a range of 1.5 mm to 3.0 mm.

In some embodiments, the liquid protection shield further comprises: a barrier wall disposed at an end of the sensor tip housing portion that is opposite the shoulder portion, the plurality of apertures being disposed proximate to the barrier wall.

In some embodiments, the sensor tip housing portion defines a tip receiving region that is substantially encapsulated by the sidewall of the sensor tip housing portion and the barrier wall, a sensor tip of the sensor probe being disposed in the tip receiving region.

In some embodiments, the liquid protection shield is fabricated from stainless steel.

In some embodiments, the shoulder portion further comprises an internal threaded region that is threaded with an external threaded region of the sensor probe.

In some embodiments, the liquid protection shield is welded into an opening in the exhaust pipe.

In some embodiments, the shoulder portion further comprises a flat face that interrupts the substantially cylindrical shape of the shoulder portion.

In some embodiments, the exhaust pipe is oriented substantially vertically with respect to gravity.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block schematic diagram of an example aftertreatment system;

FIG. 2 is a perspective view of an example liquid protection shield for a particulate matter sensor used in an aftertreatment system, such as the example aftertreatment system shown in FIG. 1;

FIG. 3 is a top view of the example liquid protection shield shown in FIG. 2;

FIG. 4 is a side cross-sectional view of the example liquid protection shield taken along the line A-A of FIG. 3;

FIG. 5 is a side view of the example liquid protection shield shown in FIG. 2;

FIG. 6 is a top cross-sectional view of the example liquid protection shield taken along the line B-B of FIG. 5;

FIG. 7 is a side view of an example liquid protection shield and particulate matter sensor in a disassembled state;

FIG. 8 is a side view of an example liquid protection shield and particulate matter sensor in an assembled state;

FIG. 9 is a side cross-sectional view of the example liquid protection shield and particulate matter sensor in the assembled state.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatuses, and systems for protecting particulate matter sensors from water intrusion within an aftertreatment system of an internal combustion engine system. The various concepts introduced above and discussed in greater detail below may be implemented in any of numerous ways, as the described concepts are not limited to any particular manner of implementation. Examples of specific implementations and applications are provided primarily for illustrative purposes.

### I. Overview

In some vehicles, such as semi-trailer trucks or tractors, an outlet of an exhaust system is vertical or substantially vertical relative to the vehicle. Thus, an end opening of the exhaust may be open and exposed to the environment, thereby potentially exposing any components within the exhaust system to any environmental conditions. In some exhaust systems, a sensor module may be located downstream of an SCR catalyst to detect one or more emissions in the exhaust flow after the SCR catalyst. For example, a NOₓ sensor, a CO sensor, and/or a particulate matter sensor may be positioned downstream of the SCR catalyst to detect NOₓ, CO, and/or particulate matter within the exhaust gas exiting the exhaust of the vehicle. Such emission sensors may be useful to provide feedback to a controller to modify an operating parameter of the aftertreatment system of the vehicle. For example, a NOₓ sensor may be utilized to detect the amount of NOₓ exiting the vehicle exhaust system and, if the NOₓ detected is too high or too low, the controller may modify an amount of reductant delivered by a dosing module. A CO and/or a particulate matter sensor may also be utilized.

In some implementations, the sensor probe may be located in the vertical portion of the exhaust system of the vehicle. Thus, the sensor probe may be, at least partially, exposed to the environmental conditions the outlet or end opening of the exhaust system is exposed to, such as rain, snow, hail, etc. For example, fluid may fall into the exhaust outlet and, in some instances, enter the sensor probe, thereby potentially damaging or causing the sensor of the sensor probe to fail. In other instances, fluid may enter the sensor probe in other manners, such as during cleaning of the vehicle. Such fluid intrusion failure modes may be reduced if the fluid is prevented or substantially deflected away from the sensor probe and/or the sensor. In some implementations, a liquid protection shield may be provided with the sensor probe such that the shield deflects liquid away from the sensor, thereby reducing and/or potentially eliminating incidents of fluid intrusion failure modes. In addition, such a shield may be constructed such that exhaust gases that are sensed by the sensor probe are released into the exhaust gas flow path to prevent gaseous buildup at the sensor.

### II. Overview of Aftertreatment System

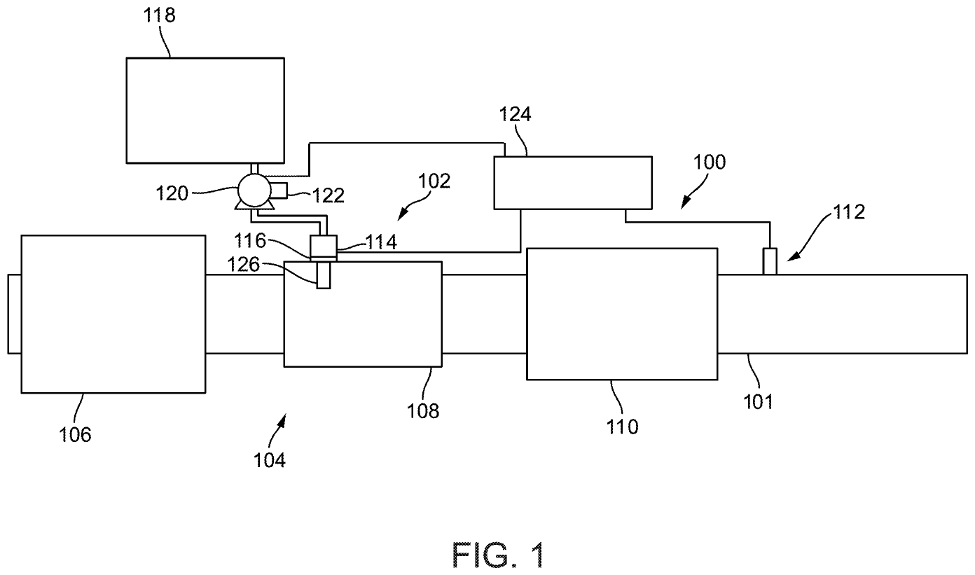

FIG. 1 depicts an aftertreatment system 100 having an example reductant delivery system 102 for an exhaust system 104. The aftertreatment system 100 also includes a particulate filter (e.g., a diesel particulate filter (DPF) 106, a decomposition chamber 108 (e.g., reactor, reactor pipe, etc.), a SCR catalyst 110, an exhaust pipe 101, and a sensor 112 disposed on the exhaust pipe 101. In some embodiments, sensor 112 is a particulate matter sensor. The exhaust pipe 101 may be oriented substantially vertically with respect to gravity (e.g., at an angle of 90±10 degrees with respect to gravity.)

The DPF 106 is configured to (e.g., structured to, able to, etc.) remove particulate matter, such as soot, from exhaust gas flowing in the exhaust system 104. The DPF 106 includes an inlet, where the exhaust gas is received, and an outlet, where the exhaust gas exits after having particulate matter substantially filtered from the exhaust gas and/or converting the particulate matter into carbon dioxide. In some implementations, the DPF 106 may be omitted.

The decomposition chamber 108 is configured to convert a reductant into ammonia. The reductant may be, for example, urea, diesel exhaust fluid (DEF), Adblue®, an urea water solution (UWS), an aqueous urea solution (e.g., AUS32, etc.), and other similar fluids. The decomposition chamber 108 includes a reductant delivery system 102 having a doser or dosing module 114 configured to dose the reductant into the decomposition chamber 108 (e.g., via an injector). In some implementations, the reductant is injected upstream of the SCR catalyst 110. The reductant droplets then undergo the processes of evaporation, thermolysis, and hydrolysis to form gaseous ammonia within the exhaust system 104. The decomposition chamber 108 includes an inlet in fluid communication with the DPF 106 to receive the exhaust gas containing NOₓ emissions and an outlet for the exhaust gas, NOₓ emissions, ammonia, and/or reductant to flow to the SCR catalyst 110.

The decomposition chamber 108 includes the dosing module 114 mounted to the decomposition chamber 108 such that the dosing module 114 may dose the reductant into the exhaust gases flowing in the exhaust system 104. The dosing module 114 may include an insulator 116 interposed between a portion of the dosing module 114 and the portion of the decomposition chamber 108 on which the dosing module 114 is mounted. The dosing module 114 is fluidly coupled to (e.g., fluidly configured to communicate with, etc.) a reductant source 118. The reductant source 118 may include multiple reductant sources 118. The reductant source 118 may be, for example, a diesel exhaust fluid tank containing Adblue®.

A supply unit or reductant pump 120 is used to pressurize the reductant from the reductant source 118 for delivery to the dosing module 114. In some embodiments, the reductant pump 120 is pressure controlled (e.g., controlled to obtain a target pressure, etc.). The reductant pump 120 includes a filter 122. The filter 122 filters (e.g., strains, etc.) the reductant prior to the reductant being provided to internal components (e.g., pistons, vanes, etc.) of the reductant pump 120. For example, the filter 122 may inhibit or prevent the transmission of solids (e.g., solidified reductant, contaminants, etc.) to the internal components of the reductant pump 120. In this way, the filter 122 may facilitate prolonged desirable operation of the reductant pump 120. In some embodiments, the reductant pump 120 is coupled to a chassis of a vehicle (e.g., maritime vehicle, boat, shipping boat, barge, container ship, terrestrial vehicle, construction vehicle, truck, etc.) associated with the aftertreatment system 100.

The dosing module 114 and reductant pump 120 are also electrically or communicatively coupled to a controller 124. The controller 124 is configured to control the dosing module 114 to dose the reductant into the decomposition chamber 108. The controller 124 may also be configured to control the reductant pump 120. The controller 124 may include a microprocessor, an application-specific integrated circuit (ASIC), a field-programmable gate array (FPGA), etc., or combinations thereof. The controller 124 may include memory, which may include, but is not limited to, electronic, optical, magnetic, or any other storage or transmission device capable of providing a processor, ASIC, FPGA, etc. with program instructions. This memory may include a memory chip, Electrically Erasable Programmable Read-Only Memory (EEPROM), Erasable Programmable Read Only Memory (EPROM), flash memory, or any other suitable memory from which the associated controller can read instructions. The instructions may include code from any suitable programming language.

The SCR catalyst 110 is configured to assist in the reduction of NOₓ emissions by accelerating a NOₓ reduction process between the ammonia and the NOₓ of the exhaust gas into diatomic nitrogen, water, and/or carbon dioxide. The SCR catalyst 110 includes an inlet in fluid communication with the decomposition chamber 108 from which exhaust gas and reductant are received and an outlet in fluid communication with an end of the exhaust system 104.

The exhaust system 104 may further include an oxidation catalyst (e.g., a diesel oxidation catalyst (DOC)) in fluid communication with the exhaust system 104 (e.g., downstream of the SCR catalyst 110 or upstream of the DPF 106) to oxidize hydrocarbons and carbon monoxide in the exhaust gas.

In some implementations, the DPF 106 may be positioned downstream of the decomposition chamber 108. For instance, the DPF 106 and the SCR catalyst 110 may be combined into a single unit. In some implementations, the dosing module 114 may instead be positioned downstream of a turbocharger or upstream of a turbocharger.

The sensor 112 may be coupled to the exhaust system 104 to detect a condition of the exhaust gas flowing through the exhaust system 104. In some implementations, the sensor 112 may have a portion disposed within the exhaust system 104; for example, a tip of the sensor 112 may extend into a portion of the exhaust system 104. In other implementations, the sensor 112 may receive exhaust gas through another conduit, such as one or more sample pipes extending from the exhaust system 104. While the sensor 112 is depicted as positioned downstream of the SCR catalyst 110, it should be understood that the sensor 112 may be positioned at any other position of the exhaust system 104, including upstream of the DPF 106, within the DPF 106, between the DPF 106 and the decomposition chamber 108, within the decomposition chamber 108, between the decomposition chamber 108 and the SCR catalyst 110, within the SCR catalyst 110, or downstream of the SCR catalyst 110. In addition, two or more sensors 112 may be utilized for detecting a condition of the exhaust gas, such as two, three, four, five, or six sensors 112 with each sensor 112 located at one of the aforementioned positions of the exhaust system 104.

The dosing module 114 includes a dosing lance assembly 126. The dosing lance assembly 126 includes a delivery conduit (e.g., delivery pipe, delivery hose, etc.). The delivery conduit is fluidly coupled to the reductant pump 120. The dosing lance assembly 126 includes at least one injector. The injector is configured to dose the reductant into the exhaust gases (e.g., within the decomposition chamber 108, etc.). While not shown, it is understood that the dosing module 114 may include a plurality of injectors.

### III. Liquid Protection Shield

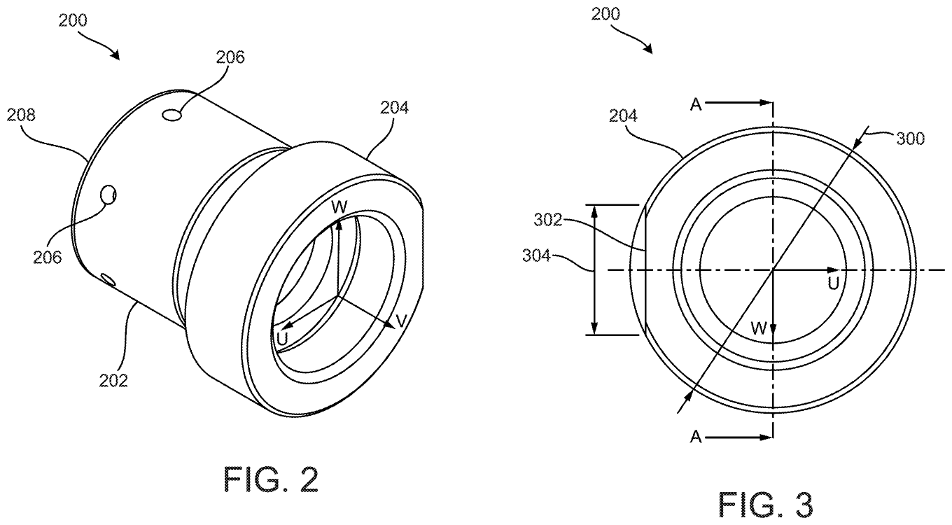

FIG. 2 illustrates a perspective view of an example liquid protection shield 200. The liquid protection shield 200 may be coupled to a particulate matter sensor (e.g., sensor 112) in an internal combustion engine system. Liquid protection shield 200 is shown to include a sensor tip housing portion 202 and a shoulder portion 204. The sensor tip housing portion 202 and the shoulder portion 204 are integrally formed or are otherwise coupled to each other using any suitable method. Both the sensor tip housing portion 202 and the shoulder portion 204 can be a substantially cylindrical shape that collectively define a central passage for a particulate matter sensor to be inserted into the shield 200 such that a tip of the sensor resides within the sensor tip housing portion 202. In other implementations, the sensor tip housing portion 202 and the shoulder portion 204 may have any geometry required to accommodate the insertion of the sensor.

The sensor tip housing portion 202 is further shown to include multiple apertures 206 formed through a sidewall of the housing portion 202. The apertures 206 may be positioned near a barrier wall 210 located at the opposite end of the shield 200 from the shoulder portion 204. The size, location, and pattern of the apertures 206 may be selected to permit exhaust gas to enter the liquid protection shield 200 and flow past the tip of a particulate matter sensor before exiting the shield 200. At the same time, the characteristics of the apertures 206 may be selected to prevent water or other fluid from entering the portion 202 and contaminating the particulate matter sensor.

In an exemplary embodiment, the liquid protection shield 200 is fabricated from a high grade steel (e.g., AISI 316 stainless steel). In other embodiments, the liquid protection shield 200 can be fabricated from any material that can withstand exposure to ammonia, which is often present in exhaust gases. In further embodiments, the liquid protection shield 200 can be fabricated from a material with good welding characteristics, since the liquid protection shield 200 can be coupled to an exhaust outlet using a welding process.

FIG. 3 illustrates a top view of the liquid protection shield 200. In an exemplary embodiment, an outer diameter 300 of the shoulder portion 204 ranges from 30 mm to 33 mm (note: all ranges disclosed herein are inclusive). The substantially cylindrical shape of the shoulder portion 204 is shown to be interrupted by a flat face 302. The flat face 302 may be utilized to orient the liquid protection shield 200 relative to the exhaust outlet such that the apertures 206 are consistently located and the accuracy of the sensor is maintained. In an exemplary embodiment, a height 304 of the flat face 302 ranges from 12 mm to 15 mm.

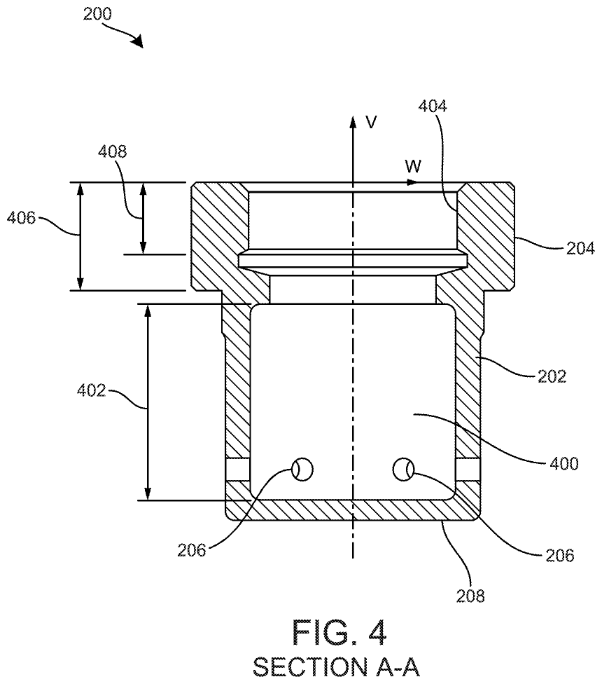

Referring now to FIG. 4, a side cross-sectional view of the liquid protection shield 200 taken about the line A-A of FIG. 3 is shown. The sensor tip housing portion 202 is shown to define a tip receiving region 400. When a particulate matter sensor is coupled to the liquid protection shield 200, the sensor tip resides within the tip receiving region 400. As shown, the tip receiving region 400 is substantially contained or encapsulated by the sidewall of the sensor tip housing portion 202 and the barrier wall 208 to protect against corrosive fluid intrusion, although apertures 206 permit a flow of exhaust gases to enter and exit the tip receiving region 400. In an exemplary embodiment, a height 402 of the tip receiving region 400 ranges from 17 to 21 mm.

Shoulder portion 204 is shown to include an internal threaded region 404. The internal threaded region 404 can include threads configured to couple to a threaded portion of the particulate matter sensor in order to retain the sensor tip within tip receiving region 400. Thus, internal threaded region 404 may include threads having any diameter and pitch required to couple to the particulate matter sensor. In an exemplary embodiment, a height 406 of the shoulder portion 204 ranges from 9 mm to 12 mm, and a depth 408 of the internal threaded region 404 is at least 7 mm.

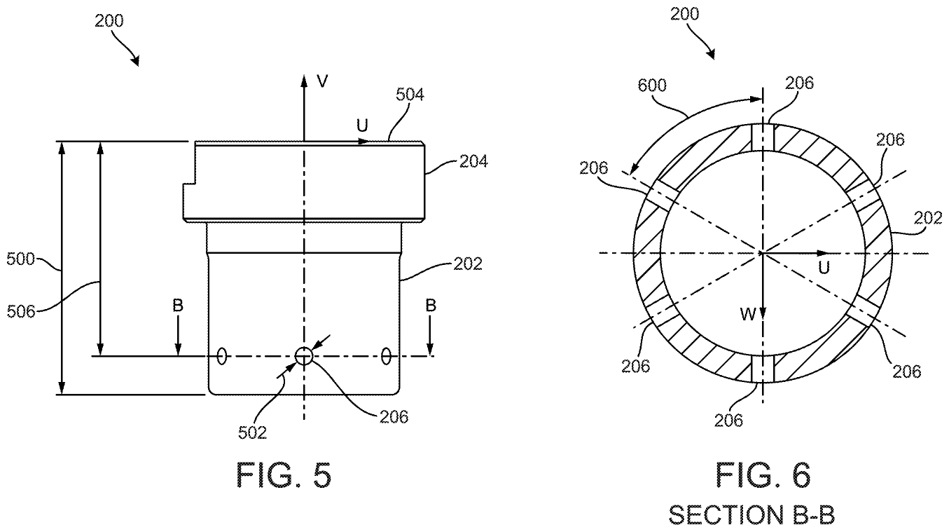

FIG. 5 illustrates a side view of the liquid protection shield 200. In an exemplary embodiment, an overall height 500 of the shield 200 ranges from 30 to 36 mm. As described above, the size of the apertures 206 may be chosen to permit a free flow of exhaust gas through the sensor tip housing portion 202. In an exemplary embodiment, a diameter 502 of each aperture 206 ranges from 1.5 mm to 3.0 mm, and a dimension 506 from an upper surface 504 of the shoulder portion 204 to the apertures 206 ranges from 26 mm to 30 mm. Although the implementation depicted and described herein includes identically-sized apertures 206 having circular shapes, in other embodiments, the apertures 206 may have different sizes relative to each other, or may have non-circular geometry (e.g., apertures may be oval or slot-shaped). For example, based on an orientation in which the liquid protection shield 200 is installed within an exhaust pipe, apertures directly situated in an exhaust flow path or an area less susceptible to water intrusion may be larger than inlet apertures that are not situated in the exhaust flow path or an area that is more susceptible to water intrusion.

Referring now to FIG. 6, a top cross-sectional view of the liquid protection shield 200 taken about the line B-B of FIG. 5 is depicted. In an exemplary embodiment, the liquid protection shield 200 includes six apertures 206 evenly distributed about the circumference of the sensor tip housing portion 202. In other words, an angle 600 between adjacent apertures 206 is about 60 degrees. In other embodiments, the liquid protection shield 200 may include a different number of apertures 206 (e.g., a range of two apertures to nine apertures), or the apertures 206 may be arranged in a different pattern (e.g., a staggered pattern, a pattern with multiple rows of apertures).

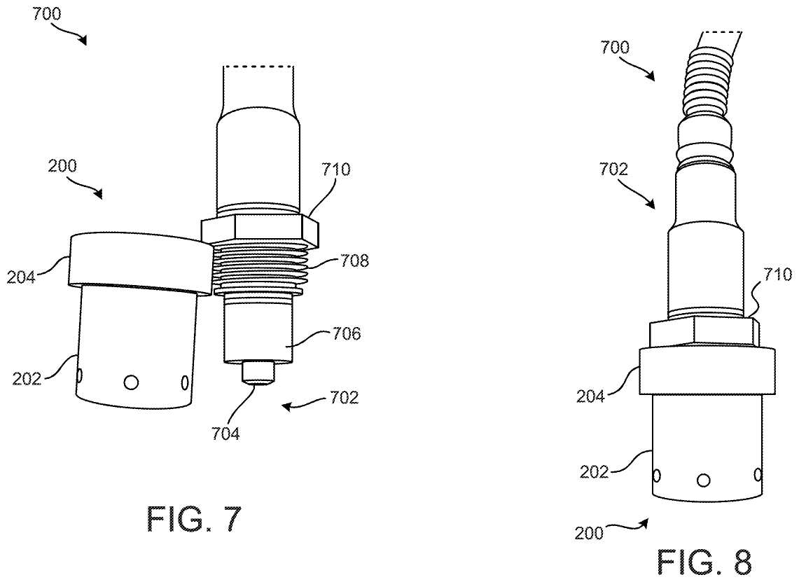

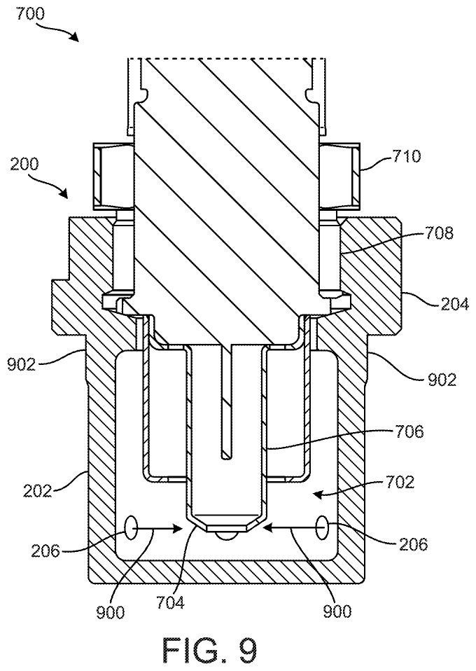

Turning now to FIG. 7, an example assembly 700 including the liquid protection shield 200 and a particulate matter sensor 702 is shown in a disassembled configuration. The particulate matter sensor 702 is shown to include a sensor tip 704 that is coupled to a sensor body 706. The sensor tip 704 may be configured to sense particulate matter in exhaust gases that pass through the liquid protection shield 200. When assembly 700 is in an assembled configuration (as shown in FIGS. 8 and 9), both the sensor tip 704 and the sensor body 706 are positioned inside the main body portion 202 of the liquid protection shield 200. Referring specifically to FIG. 9, the sensor tip 704 is shown to be positioned in the flow path 900 of exhaust gases to ensure optimal functioning of the particulate matter sensor 702

Moving away from the sensor tip 704, the sensor 702 is further shown to include an external threaded portion 708 and a nut 710. External threaded portion 708 is configured to couple to the internal threaded region 404 of the shoulder portion 204, as described above with reference to FIG. 4, and when the sensor 702 is fully seated within the liquid protection shield 200, the nut 710 is situated flush against the shoulder portion 204. In an exemplary embodiment, the installation process for the sensor 702 is as follows: the liquid protection shield 200 is welded into an opening in the exhaust pipe (not shown), and the particulate matter sensor 702 is screwed into the liquid protection shield 200. In another embodiment, the sensor tip housing portion 202 includes an external threaded portion 902 located near the region where the sensor tip housing portion 202 is coupled to the shoulder portion 204. In this embodiment, the particulate matter sensor 702 is screwed into the liquid protection shield 200, and then the assembly 700 is screwed into the exhaust pipe using the external threaded portion 902.

### IV. Construction of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” generally,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “attached,” “fastened,” “fixed,” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

The terms “fluidly coupled,” “fluidly communicable with,” and the like, as used herein, mean the two components or objects have a pathway formed between the two components or objects in which a fluid, such as air, liquid reductant, gaseous reductant, aqueous reductant, gaseous ammonia, etc., may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the system shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the application, the scope being defined by the claims that follow. When the language “a portion” is used, the item can include a portion and/or the entire item unless specifically stated to the contrary.

What is claimed is:

1. A liquid protection shield for a sensor probe in an exhaust system, the liquid protection shield comprising:
a sensor tip housing portion having a substantially cylindrical shape and comprising a plurality of apertures formed through a sidewall of the sensor tip housing portion; and
a shoulder portion integrally coupled to the sensor tip housing portion and having a substantially cylindrical shape;
wherein the sensor tip housing portion and the shoulder portion collectively define a central passage for the sensor probe.

2. The liquid protection shield of claim 1, wherein the plurality of apertures comprises a range of two apertures to nine apertures.

3. The liquid protection shield of claim 1, wherein the plurality of apertures comprises six apertures disposed at equal intervals about a circumference of the sensor tip housing portion.

4. The liquid protection shield of claim 1, wherein a diameter of each of the plurality of apertures is in a range of 1.5 mm to 3.0 mm.

5. The liquid protection shield of claim 1, further comprising:
a barrier wall disposed at an end of the sensor tip housing portion that is opposite the shoulder portion,
wherein the plurality of apertures are disposed proximate to the barrier wall.

6. The liquid protection shield of claim 5, wherein the sensor tip housing portion defines a tip receiving region that is substantially encapsulated by the sidewall of the sensor tip housing portion and the barrier wall, the tip receiving region configured to receive a sensor tip of the sensor probe.

7. The liquid protection shield of claim 1, wherein the liquid protection shield is fabricated from stainless steel.

8. The liquid protection shield of claim 1, wherein the shoulder portion further comprises an internal threaded region configured to be threaded with an external threaded region of the sensor probe.

9. The liquid protection shield of claim 1, wherein the shoulder portion further comprises a flat face that interrupts the substantially cylindrical shape of the shoulder portion.

10. An aftertreatment system for treating constituents of an exhaust gas generated by an engine, comprising:
an exhaust pipe;
at least one aftertreatment component disposed within the exhaust pipe;
a liquid protection shield coupled to a wall of the exhaust pipe, the liquid protection shield comprising:
a sensor tip housing portion having a substantially cylindrical shape and comprising a plurality of apertures formed through a sidewall of the sensor tip housing portion, and
a shoulder portion integrally coupled to the sensor tip housing portion and having a substantially cylindrical shape,
wherein the sensor tip housing portion and the shoulder portion collectively define a central passage for the sensor probe; and
a sensor probe, at least a portion of the sensor probe being disposed in the central passage.

11. The aftertreatment system of claim 10, wherein the plurality of apertures comprises a range of two apertures to nine apertures.

12. The aftertreatment system of claim 10, wherein the plurality of apertures comprises six apertures disposed at equal intervals about a circumference of the sensor tip housing portion.

13. The aftertreatment system of claim 10, wherein a diameter of each of the plurality of apertures is in a range of 1.5 mm to 3.0 mm.

14. The aftertreatment system of claim 10, wherein the liquid protection shield further comprises:
a barrier wall disposed at an end of the sensor tip housing portion that is opposite the shoulder portion, the plurality of apertures being disposed proximate to the barrier wall.

15. The aftertreatment system of claim 14, wherein the sensor tip housing portion defines a tip receiving region that is substantially encapsulated by the sidewall of the sensor tip housing portion and the barrier wall, a sensor tip of the sensor probe being disposed in the tip receiving region.

16. The aftertreatment system of claim 10, wherein the liquid protection shield is fabricated from stainless steel.

17. The aftertreatment system of claim 10, wherein the shoulder portion further comprises an internal threaded region that is threaded with an external threaded region of the sensor probe.

18. The aftertreatment system of claim 17, wherein the liquid protection shield is welded into an opening defined in the exhaust pipe.

19. The aftertreatment system of claim 10, wherein the shoulder portion further comprises a flat face that interrupts the substantially cylindrical shape of the shoulder portion.

20. The aftertreatment system of claim 10, wherein the exhaust pipe is oriented substantially vertically with respect to gravity.
